(19) United States
(12) Patent Application Publication
(10) Pub. No.: US 2026/0277029 A1
(43) Pub. Date: Sep. 17, 2026

(54) Flexible Eyeglass Frames

(71) Applicant: Gine'a Jhabonite Brown, MARGATE, FL (US)

(72) Inventor: Gine'a Jhabonite Brown, MARGATE, FL (US)

(21) Appl. No.: 19/549,972

(22) Filed: Feb. 25, 2026

Related U.S. Application Data
(60) Provisional application No. 63/772,324, filed on Mar. 14, 2025.

(51) Int. Cl. G02C 13/00

(52) U.S. Cl. CPC G02C 13/001

(57) ABSTRACT

A flexible protective device for temporary eyeglass frame repair that comprises a glasses holding portion conforming to the front frame structure, a left leg protective portion supporting the left temple, a right leg protective portion supporting the right temple, an access opening with retention mechanism, and flexible material forming an integrated structure. The device molds to eyeglass frames and fits around their perimeter like a phone case or glove, holding broken frame components in alignment. The device allows wearers to continue using their eyeglasses while awaiting professional repair or replacement, providing immediate functional restoration without adhesives or damage to the frames. The flexible material enables easy insertion and removal through the access opening, accommodating various frame sizes and geometries. The device is lightweight, simple to apply, and removable, serving as a temporary solution to restore both usability and cosmetic acceptability of broken eyeglass frames.

### FIELD OF THE INVENTION

The present invention relates generally to eyeglass repair and restoration. More specifically, the present invention is a flexible protective frame that molds to broken eyeglass frames to allow users to continue wearing them while waiting to repair or replace them.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

The present invention relates to a flexible eyeglass frame that molds to broken eyeglass frames to allow users to continue wearing them while awaiting repair or replacement. The flexible frame serves as an enclosure that fits around the perimeter of eyeglass frames, similar to a phone case or glove. The flexible frame molds to eyeglass frames to fit them like a glove and helps hold broken legs or other broken components in place. The invention is lightweight and easy to use.

### BACKGROUND OF THE INVENTION

Eyeglass frames are commonly subject to damage during normal use, including breakage of the frame legs (temples), bridge fractures, or complete frame separation. When an eyeglass frame becomes structurally compromised, the wearer loses immediate access to corrected vision and faces significant inconvenience and expense.

Professional repair or replacement of damaged eyeglass frames may be delayed for various reasons, including cost, availability of replacement frames, and waiting times for professional service. During such delays, wearers must contend with uncorrected vision or resort to temporary measures.

Conventional temporary remedies for broken eyeglass frames present significant limitations. Adhesive-based solutions such as glue or tape may be visually unattractive and may cause further damage to the frame material. Makeshift binding methods using string, rubber bands, or wire are uncomfortable, cosmetically unacceptable, and frequently fail to maintain proper frame alignment. Such approaches may also cause additional structural damage or create safety hazards for the wearer.

Accordingly, there is a need in the art for a protective device that can be quickly and easily applied to a damaged eyeglass frame without professional assistance or specialized tools. Such a device should be removable and reusable, mold or conform to the specific geometry of the eyeglass frame, retain broken components in proper alignment, and restore both functional usability and cosmetically acceptable appearance until the eyeglass frames can be professionally repaired or replaced.

The present invention is intended to solve the problems associated with conventional devices and methods and provide improvements on these devices.

### BRIEF DESCRIPTION OF THE DRAWINGS

FIG. 1 is a perspective view of the protective eyewear device of the present invention.

FIG. 2 is a front view of the present invention in one embodiment.

FIG. 3 is a side profile view of the present invention in one embodiment.

FIG. 4 is an exploded assembly view of the present invention installed on an eyeglass frame

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the eyeglass repair, optometry, and protective device arts that the present disclosure relating to the flexible eyeglass frame protection system has broad utility and application. The disclosed flexible protective frames may be used in eyeglass repair applications, temporary frame stabilization, emergency eyewear protection, and various retail and clinical eyecare settings. As should be understood, any embodiment of the flexible eyeglass frame protection system may incorporate only one or a plurality of the above-disclosed aspects of the disclosure and may further incorporate only one or a plurality of the above-disclosed features, including but not limited to: flexible silicone construction, targeted reinforcement zones, multiple closure mechanisms, variable sizing, and decorative customizations.

Furthermore, any embodiment discussed and identified as being “preferred”—such as the medical-grade silicone sleeve with Velcro closure mechanism in multiple size ranges—is considered to be part of a best mode contemplated for carrying out the embodiments of the present disclosure. Other embodiments also may be discussed for additional illustrative purposes in providing a full and enabling disclosure, including single-use disposable versions, multi-segment designs, and application-specific variants for children's frames or specialized eyewear. Moreover, many embodiments, such as adaptations, variations, modifications, and equivalent arrangements—including alternative flexible materials, different closure systems, various reinforcement patterns, and modified insertion mechanisms—will be implicitly disclosed by the embodiments described herein and fall within the scope of the present disclosure.

Accordingly, while embodiments are described herein in detail in relation to one or more embodiments involving flexible protective frames for broken eyeglasses, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing herefrom that does not explicitly appear in the claim itself.

Thus, for example, any sequence(s) and/or temporal order of steps of various processes or methods that are described herein—such as the steps for inserting eyeglasses, securing protective frames, wearing the system, and removing the protective frame—are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods for applying and using the flexible eyeglass frame protection system generally may be carried out in various different sequences and orders while still falling within the scope of the present disclosure. For example, a user may secure the protective frame before or after inserting the eyeglasses, and may inspect the frame before or after insertion. Accordingly, it is intended that the scope of patent protection is to be defined by the issued claim(s) rather than the description set forth herein.

Additionally, it is important to note that each term used herein refers to that which an ordinary artisan in the eyeglass design, protective device, and flexible material fields would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail. For example, the term “flexible frame” as used herein refers to a protective outer structure made of pliable material designed to encompass eyeglass frames, and should not be confused with the eyeglass frames themselves.

Furthermore, it is important to note that, as used herein, “a” and “an” each generally denotes “at least one,” but does not exclude a plurality unless the contextual use dictates otherwise. Accordingly, references to “a flexible frame” or “an access opening” include embodiments with one or more flexible frames or access openings. When used herein to join a list of items, “or” denotes “at least one of the items,” but does not exclude a plurality of items of the list. For example, “silicone or rubber materials” encompasses embodiments using silicone, rubber, or combinations thereof. Finally, when used herein to join a list of items, “and” denotes “all of the items of the list.” For example, “flexible material and reinforcement zones and closure mechanisms” encompasses embodiments incorporating all three elements.

The following detailed description refers to the accompanying drawings of the flexible eyeglass frame protection system. Wherever possible, the same reference numbers are used in the drawings and the following description to refer to the same or similar elements throughout the various views and embodiments. While many embodiments of the disclosure may be described herein, modifications, adaptations, and other implementations are possible. For example, substitutions, additions, or modifications may be made to the elements illustrated in the drawings—such as alternative materials, different reinforcement patterns, or modified closure mechanisms—and the methods described herein may be modified by substituting, reordering, or adding stages to the disclosed methods for applying, wearing, and removing the protective frames. Accordingly, the following detailed description does not limit the disclosure. Instead, the proper scope of the disclosure is defined by the claims found herein and/or issuing herefrom. The present disclosure contains headers and organizational sections. It should be understood that these headers are used as references and are not to be construed as limiting upon the subject matter disclosed under the header.

The present disclosure includes many aspects and features relating to the flexible eyeglass frame protection system, including structural components, material compositions, manufacturing processes, sizing options, closure mechanisms, and methods of use. Moreover, while many aspects and features relate to, and are described in the context of flexible protective systems, apparatuses, and methods for temporarily protecting and stabilizing broken eyeglass frames, embodiments of the present disclosure are not limited to use only in this context. The flexible protective frame technology disclosed herein may have broader applications in protecting other optical devices, eyewear accessories, sports glasses, safety glasses, or other frame-based devices that require temporary structural support or protection during repair or replacement cycles.

The flexible eyeglass frame protection system represents an innovative solution to the problem of broken eyeglass frames, providing users with immediate temporary functionality while awaiting professional repair or replacement. The system encompasses various embodiments with different materials, construction methods, sizing options, and closure mechanisms, all of which fall within the scope of the present invention. It is intended that all such variations and equivalent implementations shall be encompassed within the scope of the patent protection afforded by the claims hereof.

The present invention is for eyeglass wearers that break their eyeglass frames and need a temporary solution for repair or replacement. The present invention serves like a phone case or a glove to eyeglass frames. The present invention is a flexible eyeglass frame that molds to broken eyeglass frames and fits around the perimeter of the glasses so that a user can still wear the glasses until the frames are repaired or replaced.

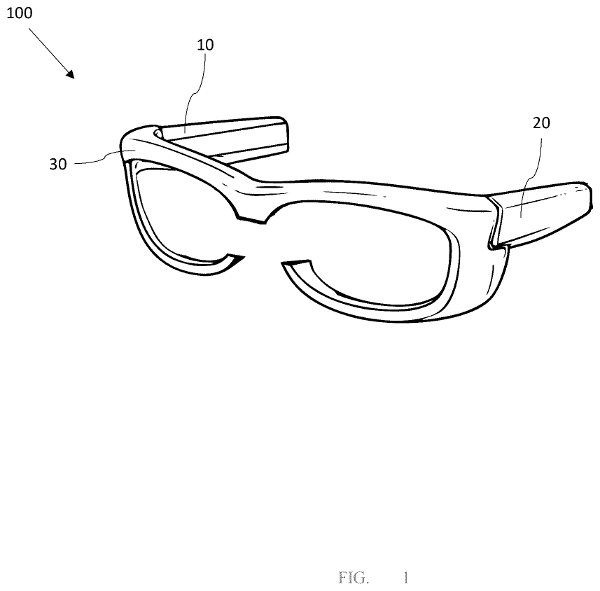

As shown in FIG. 1, the present invention provides a device 100 comprising: (1) a glasses holding portion 30, (2) a left leg protective portion 20, (3) a right leg protective portion 10, (4) an access opening with retention mechanism, and (5) flexible material forming the integrated structure.

### Glasses Holding Portion

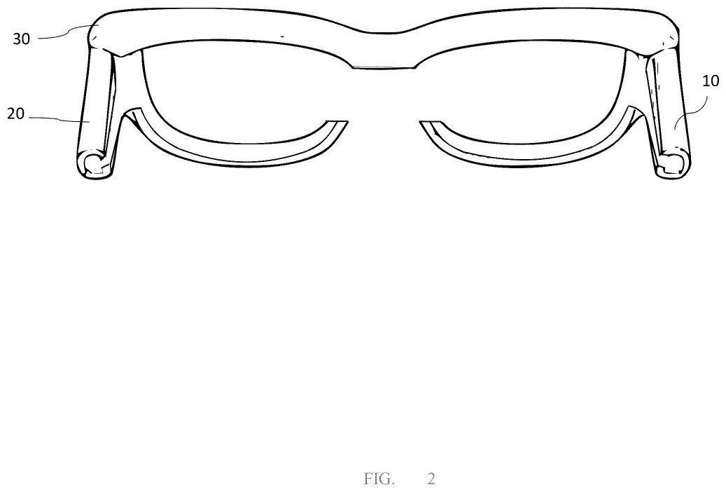

The glasses holding portion 30 may comprise the central protective enclosure that may surround and support the front frame structure of the eyeglass frame 40, as shown in FIG. 1 and FIG. 2. This component 30 may be configured to wrap around the front perimeter of the eyeglass frame 40 and may directly contact and support the lens-holding portions and bridge area of the eyeglass frames 40.

In one embodiment, the glasses holding portion 30 may be a continuous protective sleeve that may conform to the contoured shape of the eyeglass frame 40 front. The glasses holding portion 30 may provide primary structural support across the bridge area where the two lens-holders meet.

In a preferred embodiment, the glasses holding portion 30 may be integrally connected to both the left leg portion 20 and the right leg portion 10, creating a unified protective structure 100 as depicted in FIG. 1. The connection may occur at the end pieces (hinge areas) of the eyeglass frame 40, where the temples attach to the front frame.

In some embodiments, the transition between the glasses holding portion 30 and the leg portions 20, 10 may incorporate flexible zones that may allow articulation similar to the natural hinge movement of eyeglass temples on frame 40.

### Left Leg Protective Portion

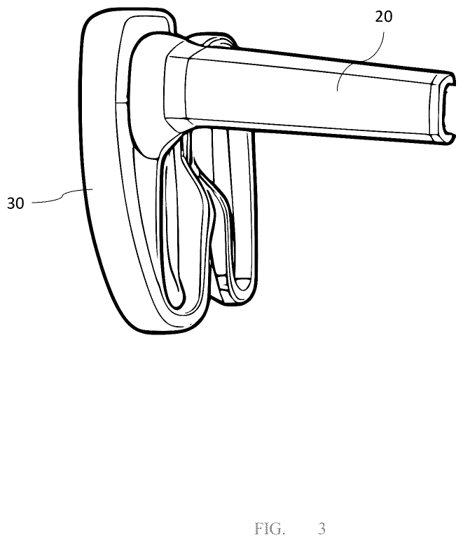

The left leg protective portion 20 may comprise a protective sleeve that may enclose and support the left temple (left leg) of the eyeglass frame 40, extending from the left end piece (hinge area) to the left temple tip, as illustrated in FIG. 1, FIG. 2, and FIG. 3.

In one embodiment, the left leg portion 20 may be designed as an elongated flexible sleeve that may fit over the temple. This component 20 may provide structural support to prevent further bending, fracturing, or misalignment of a broken left temple. The left leg portion 20 may help hold the broken left leg of the eyeglass frame 40 in place.

In some embodiments, the left leg portion 20 may incorporate internal structural reinforcements positioned along the length of the temple to stabilize break points, as shown in FIG. 3.

In other embodiments, the left leg portion 20 may include localized thickening at the hinge area (end piece connection point) to provide maximum support where temple breaks most commonly occur.

In a preferred embodiment, the left leg portion 20 may feature graduated flexibility, with firmer material at the hinge connection transitioning to more flexible material toward the temple tip for natural ear placement.

The left leg portion 20 may connect to the glasses holding portion 30 at the left end piece (hinge connection area) of frame 40. In one embodiment, this connection may be integral and molded as one continuous piece, as shown in FIG. 1.

In some embodiments, the connection may comprise a flexible joint region that may allow natural temple movement. The left leg portion 20 may remain connected throughout its entire length, maintaining continuous protective enclosure from the hinge to the temple tip.

### Right Leg Protective Portion

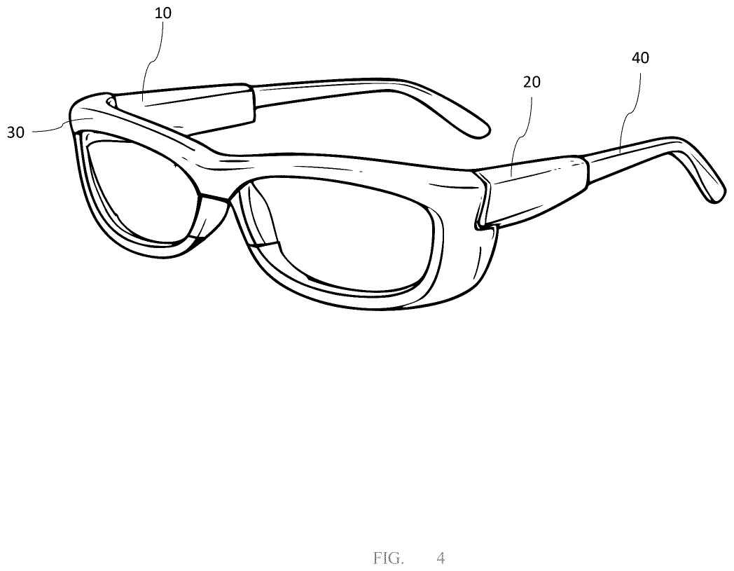

The right leg protective portion 10 may comprise a protective sleeve that may enclose and support the right temple (right leg) of the eyeglass frame 40, extending from the right end piece (hinge area) to the right temple tip, as shown in FIG. 1, FIG. 2, and FIG. 4.

In one embodiment, the right leg portion 10 may be designed as an elongated flexible sleeve that may fit over the temple. This component 10 may provide structural support to prevent further bending, fracturing, or misalignment of a broken right temple. The right leg portion 10 may help hold the broken right leg of the eyeglass frame 40 in place.

In some embodiments, the right leg portion 10 may incorporate internal structural reinforcements positioned along the length of the temple. In other embodiments, the right leg portion 10 may include localized thickening at the hinge area to provide maximum support at the most common break point, as depicted in FIG. 4.

In a preferred embodiment, the right leg portion 10 may feature graduated flexibility with firmer material at the hinge connection transitioning to more flexible material toward the temple tip.

The right leg portion 10 may connect to the glasses holding portion 30 at the right end piece (hinge connection area) of frame 40. In one embodiment, this connection may be integral or may comprise a flexible joint region that may allow natural temple movement, as shown in FIG. 1 and FIG. 4.

The right leg portion 10 may remain connected throughout its entire length, maintaining continuous protective enclosure from the hinge to the temple tip.

### Access Opening With Retention Mechanism

The access opening may comprise an opening or pathway that may allow insertion and removal of eyeglass frames 40 while maintaining a secure fit once positioned, as illustrated in FIG. 4. In one embodiment, the access opening may comprise a continuous slot positioned along one central location of the protective frame 40.

In some embodiments, the access opening may be positioned along one side of the device 100, with the slot extending partially or fully through the connection zone between the glasses holding portion 30 and the leg portions 20, 10.

The edges of the access opening may be configured with overlapping sections that may create a secure fit around the eyeglass frame 40 once insertion is complete. The overlap dimension may provide pressure contact without requiring additional fastening.

In another embodiment, mechanical snap fasteners may be distributed along the overlapping edges to provide positive mechanical retention. In a basic embodiment, the device 100 may rely solely on friction fit and elastic material tension, with no additional closure mechanism.

### Flexible Material

The device 100 of the present invention may be formed from flexible material that may allow the device to mold to eyeglass frames 40 to fit them like a glove, as shown in FIG. 1. The flexible material may comprise the integrated structure of all components (glasses holding portion 30, left leg protective portion 20, right leg protective portion 10, and access opening) as a unified protective enclosure 100.

In some embodiments, the flexible silicone material is medical-grade silicone rubber with tensile strength exceeding 1.5 MPa and elongation at break ranging from 100-300%.

The glasses holding portion 30 may serve as the central hub to which the left leg portion 20 and right leg portion 10 may connect. In one embodiment, these three components 30, 20, 10 may be integrally molded as a single unified protective structure 100 as mentioned above and shown in FIG. 1.

In some embodiments, the components 30, 20, 10 may be separately manufactured and then bonded together. The connections between the glasses holding portion 30 and each leg portion 20, 10 may occur at the end piece areas (hinge regions) of the eyeglass frame 40, where the temples attach to the front frame, as depicted in FIG. 4.

In some embodiments, the left leg protective portion 20 and right leg protective portion 10 are separable from the glasses holding portion 30, allowing users to wear only affected leg portions when only one temple is broken.

In some embodiments, these connection zones may be strengthened with localized thickening or internal reinforcement to provide rigidity at the hinge point. All components 30, 20, 10 may be formed from the same flexible material, ensuring consistent properties and seamless material bond at component junctions.

The device 100 of the present invention may be used when the user breaks one of the legs of their eyeglass frames 40 or when the eyeglass frames 40 break in half, as shown in FIG. 1 and FIG. 2. When the eyeglass frame 40 breaks down the middle (at the bridge), the device 100 may still be used to hold the eyeglass frames 40 together and in place by holding the broken leg(s) of the eyeglass frame 40 in place.

The device 100 of the present invention is light and easy to use. Users may continue to wear the glasses until the frames 40 are repaired or replaced.

Although the invention has been explained in relation to its preferred embodiment, it is to be understood that many other possible modifications and variations can be made without departing from the spirit and scope of the invention.

What is claimed is:

1. A flexible protective device for eyeglass frame repair, comprising:
a glasses holding portion configured to wrap around and support the front frame structure of an eyeglass frame, the glasses holding portion encompassing lens-holding areas and providing structural support across a bridge area;
a left leg protective portion comprising a protective sleeve that encloses and supports a left temple of the eyeglass frame;
a right leg protective portion comprising a protective sleeve that encloses and supports a right temple of the eyeglass frame;
an access opening configured to allow insertion and removal of eyeglass frames while maintaining a secure fit, the access opening having overlapping edges that create retention pressure around the eyeglass frame;
flexible silicone material forming an integrated structure connecting the glasses holding portion, left leg protective portion, and right leg protective portion as a unified protective enclosure.

2. The device of claim 1, wherein the glasses holding portion is designed as a continuous protective sleeve that conforms to the contoured shape of the eyeglass frame front.

3. The device of claim 1, wherein the left leg protective portion and right leg protective portion are each designed as elongated flexible sleeves that fit over respective temples of the eyeglass frame.

4. The device of claim 2, wherein the glasses holding portion includes localized thickening at connection zones where the glasses holding portion meets the leg portions to provide increased structural support.

5. The device of claim 3, wherein the left leg protective portion and right leg protective portion each include internal structural reinforcements positioned along the length of the respective temple to stabilize break points.

6. The device of claim 1, wherein the access opening comprises a continuous slot positioned along a central location of the protective frame.

7. The device of claim 6, wherein the continuous slot is positioned along one of the top or bottom edge of the glasses holding portion, extending across a width of the glasses holding portion.

8. The device of claim 1, wherein the overlapping edges of the access opening are configured to enable adjustable closure tension.

9. The device of claim 1, wherein the overlapping edges of the access opening are configured to provide retention force without adhesive materials.

10. The device of claim 1, wherein the overlapping edges of the access opening comprise mechanical snap fasteners distributed at regular intervals along the frame edge.

11. The device of claim 1, wherein the device relies upon friction fit and elastic material tension to provide retention without additional closure mechanisms.

12. A flexible protective device for eyeglass frame repair, comprising:
a glasses holding portion configured to wrap around and support the front frame structure of an eyeglass frame, the glasses holding portion encompassing lens-holding areas and a bridge area;
a left leg protective portion comprising an elongated flexible sleeve that encloses the left temple;
a right leg protective portion comprising an elongated flexible sleeve that encloses the right temple;
an access opening with overlapping edges along one side of the device;
flexible medical-grade silicone material forming the integrated structure;
wherein the glasses holding portion, left leg protective portion, and right leg protective portion are integrally molded as a single unified protective structure;
wherein the device is sized to accommodate eyeglass frames;
wherein the device may be inserted over broken eyeglass frames to hold broken components in proper alignment and allow continued wear until repair or replacement;
wherein the device is removable and reusable.

13. The device of claim 12, wherein the left leg protective portion and right leg protective portion each feature graduated flexibility, with firmer material at hinge connections transitioning to more flexible material toward the temple tips.

14. The device of claim 12, wherein the connection between the glasses holding portion and each leg protective portion incorporates thin-walled flexible zones allowing natural temple articulation.

15. The device of claim 12, wherein the access opening is sized to accommodate standard eyeglass frame thicknesses, with a slot width of 8-20 mm depending on device size.

16. A flexible protective device for eyeglass frame repair, comprising:
a glasses holding portion designed as a continuous protective sleeve that wraps around the front perimeter of an eyeglass frame;
a left leg protective portion designed as an elongated flexible sleeve that fits over a left temple, extending from an end piece to a temple tip;
a right leg protective portion designed as an elongated flexible sleeve that fits over a right temple, extending from an end piece to a temple tip;
an access opening with overlapping sections that create a secure fit around the eyeglass frame;
flexible silicone material forming an integrated structure;
wherein the glasses holding portion serves as a central hub to which the left leg protective portion and right leg protective portion integrally connect;
wherein the connections between the glasses holding portion and leg portions occur at hinge areas of the eyeglass frame;
wherein the device is configured to hold one or more broken legs of the eyeglass frame in place and hold broken frame components together.

17. The device of claim 16, wherein the flexible silicone material is medical-grade silicone rubber with tensile strength exceeding 1.5 MPa and elongation at break ranging from 100-300%.

18. The device of claim 16, wherein the device is manufactured in multiple sizes to accommodate various eyeglass frame dimensions, comprising small, medium, and large sizes.

19. The device of claim 16, wherein the left leg protective portion and right leg protective portion may comprise multiple interconnected flexible segments allowing greater independent flexibility and accommodation of varying temple angles.

20. The device of claim 19, wherein the left leg protective portion and right leg protective portion are separable from the glasses holding portion, allowing users to wear only affected leg portions when only one temple is broken.
